(19) United States
(12) Patent Application Publication
(10) Pub. No.: US 2023/0008422 A1
(43) Pub. Date: Jan. 12, 2023

(54) REDUCTION OF AC RESISTIVE LOSSES IN PLANAR CONDUCTORS

(71) Applicant: SMART PRONG TECHNOLOGIES, INC., Irvine, CA (US)

(72) Inventors: Philip John CRAWLEY, Mission Viejo, CA (US); Stephen W. ELLSWORTH, San Diego, CA (US)

(73) Assignee: SMART PRONG TECHNOLOGIES, INC., Irvine, CA (US)

(21) Appl. No.: 17/811,554

(22) Filed: Jul. 8, 2022

Related U.S. Application Data
(60) Provisional application No. 63/219,391, filed on Jul. 8, 2021.

(51) Int. Cl. H01F 17/00; H01F 27/28

(52) U.S. Cl. CPC H01F 17/0006; H01F 27/2804; H01F 2017/0073; H01F 2027/2819

(57) ABSTRACT

A planar inductor may include a first coil and a second coil. The first coil may include a first trace that forms a first set of turns. The second coil may include a second trace that forms a second set of turns. A distance between the turns of the first set of turns may be equal to a distance between the turns of the second set of turns. A width of the first trace may be equal to a width of the second trace. The first coil and the second coil may be physically positioned or sized according to a/b in which a represents the width of the first trace and b represents the distance between the turns of the first set of turns.

### CROSS-REFERENCE TO RELATED APPLICATION

This patent application claims the benefit of and priority to U.S. Provisional App. No. 63/219,391 filed Jul. 8, 2021, titled “REDUCTION OF AC RESISTIVE LOSES IN PLANAR CONDUCTORS,” which is incorporated in the present disclosure by reference in its entirety.

### FIELD

The aspects discussed in the present disclosure are related to reduction of alternating current (AC) resistive losses in planar conductors.

### BACKGROUND

Unless otherwise indicated in the present disclosure, the materials described in the present disclosure are not prior art to the claims in the present application and are not admitted to be prior art by inclusion in this section.

A planar inductor may include one or more coils and one or more layers of material that are manufactured as a printed circuit board (PCB). The PCB may be physically positioned proximate a core (e.g., a magnetic core). Each coil may include a different trace that forms a number of turns and controls an inductance rating of the planar inductor. Each trace may receive an AC signal and operate based on the corresponding AC signal and the number of turns.

The subject matter claimed in the present disclosure is not limited to aspects that solve any disadvantages or that operate only in environments such as those described above. Rather, this background is only provided to illustrate one example technology area where some aspects described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more aspects of the present disclosure may include a planar inductor. The planar inductor may operate according to planar magnetics. The planar inductor may include a first coil and a second coil. The first coil may include a first trace that forms a first set of turns. The second coil may include a second trace that forms a second set of turns. A distance between the turns of the first set of turns may be equal to a distance between the turns of the second set of turns. A width of the first trace may be equal to a width of the second trace. The first coil and the second coil may be physically positioned or sized according to a/b in which a represents the width of the first trace and b represents the distance between the turns of the first set of turns.

The object and advantages of the aspects will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example aspects will be described and explained with additional specificity and detail through the use of the accompanying drawings in which:

FIG. 1 illustrates an exemplary planar inductor system;

FIG. 2 illustrates an example of the planar inductor of FIG. 1;

FIGS. 3A and 3B illustrate cross sectional views of example configurations of the planar inductor of FIG. 1, and

FIGS. 4A-4D illustrate graphical representations of simulations performed using a planar inductor that is physically positioned and sized according to the first ratio and the second ratio,

all according to at least one aspect described in the present disclosure.

### DETAILED DESCRIPTION

A planar inductor (e.g., conductor) may include one or more coils and one or more layers of material that are manufactured as a PCB. The PCB may be physically positioned proximate a core (e.g., a magnetic core). For example, the PCB may be physically positioned within an opening defined by the core. As another example, the PCB may extend through an opening defined by the core. Each coil may include a different trace that forms a number of turns and controls an inductance rating of the planar inductor. Each trace may receive an AC signal and operate based on the corresponding AC signal and the number of turns.

The planar inductor may be implemented as a coupled inductor, a standalone inductor, a transformer, or some combination thereof. The planar inductor may include benefits compared to wire wound inductors. The benefits may include a lower volume, a reduced height, or some combination thereof.

A total resistance of the planar inductor may include a combination of a direct current (DC) resistance, a skin effect resistance, and a proximity effect resistance. The DC resistance may be proportional to a cross-sectional area of the one or more traces (e.g., a thickness of the traces multiplied by the width of the traces). The skin effect resistance and the proximity effect resistance may form a total AC resistance of the planar inductor.

The skin effect resistance may be proportional to a current depth penetration and may be determined according to Equation 1.

$$δ = \sqrt{\frac{π μ f}{p}} \qquad Equation 1$$

In Equation 1, p represents a material resistivity of the one or more traces, μ represents a permeability of air, and f represents a frequency of the corresponding AC signal. The proximity effect resistance may be based on an aggregate of mutual magnetic flux fields being generated by a corresponding trace and neighboring traces (e.g., physically proximate traces). The total resistance of a trace may be proportional to a geometric mean distance (GMD) between the trace and the neighboring traces. As the number of turns in the planar inductor increase, the proximity effect resistance of a trace may outweigh the skin effect resistance of the trace with regard to the total AC resistance.

The total AC resistance of the planar inductor may cause AC resistive losses during operation. It may be challenging to reduce the AC resistive losses of the planar inductor (e.g., of planar magnetic devices) compared to a wire wound inductor due to PCB manufacturing limitations, volume restrictions, or some combination thereof.

The thickness of the one or more traces (e.g., one or more PCB traces) may be limited to be equal to or between a one-ounce copper trace and a ten-ounce copper trace. Therefore, the planar inductor may include a smaller cross-sectional area compared to the wire wound inductor, which may proportionally increase the AC resistive losses. Further, the wire wound inductor may include a Litz wire, which may include a lower AC resistance compared to copper traces.

Some planar inductor technologies may increase a thickness of the one or more traces, a number of turns, a number of coils based on PCB design limitations, or some combination thereof to try and reduce AC resistive losses or to increase an inductance rating. However, these planar inductor technologies may increase the proximity effect resistance of the planar inductor, which may increase the AC resistive losses. In addition, these planar inductor technologies may increase a manufacturing cost, a circuit footprint, or some combination thereof associated with the planar inductor.

Some aspects described in the present disclosure may include a planar inductor that includes one or more coils that are positioned, sized, or some combination thereof according to a width of one or more traces, a distance between the traces, a distance between coils, or some combination thereof. The coils may be positioned and/or sized so as to reduce AC resistive losses of the planar inductor. Some aspects described in the present disclosure may include a planar inductor that is designed counter to conventional planar magnetic design practices to reduce the total AC resistance and the AC resistive losses of the planar inductor. For example, the planar inductor described in the present disclosure may include thinner traces, fewer layers, or some combination thereof compared to other planar inductor technologies to reduce the total AC resistance and the AC resistive losses (e.g., less copper may improve performance of the inductor). Meanwhile, the planar inductor described in the present disclosure may include an increased inductance rating with a reduced circuit footprint compared to other planar inductors.

The planar inductor may operate according to planar magnetics. The planar inductor may include a first coil and a second coil. The first coil may include a first trace that forms multiple turns. The second coil may include a second trace that forms multiple turns. A distance between the turns of the first trace may be equal to a distance between the turns of the second trace. A width of the first trace may be equal to a width of the second trace. The first coil and the second coil may be physically positioned, sized, or some combination thereof according to Equation 2.

a/b Equation 2

In Equation 2, a represents the width of the first trace and b represents the distance between the turns of the first trace. In some aspects, the width of the first trace and the distance between the turns of the first trace may be determined such that Equation 2 is equal to 1.3. In addition, a distance between the first coil and the second coil may be determined according to Equation 3.

1.12×b Equation 3

In Equation 3, b represents the distance between the turns of the first trace.

The planar inductor may include a coil that includes a trace, a first layer, and a second layer. The first layer may include a first set of turns formed by the trace. The second layer may include a second set of turns formed by the trace. A distance between the turns of the first set of turns may be equal to a distance between the turns of the second plurality of turns. The first layer and the second layer may be physically positioned, sized, or some combination thereof according to Equation 2. However, in these aspects, a represents the width of the trace and b represents the distance between the turns of the first set of turns.

These and other aspects of the present disclosure will be explained with reference to the accompanying figures. It is to be understood that the figures are diagrammatic and schematic representations of such example aspects, and are not limiting, nor are they necessarily drawn to scale. In the figures, features with like numbers indicate like structure and function unless described otherwise.

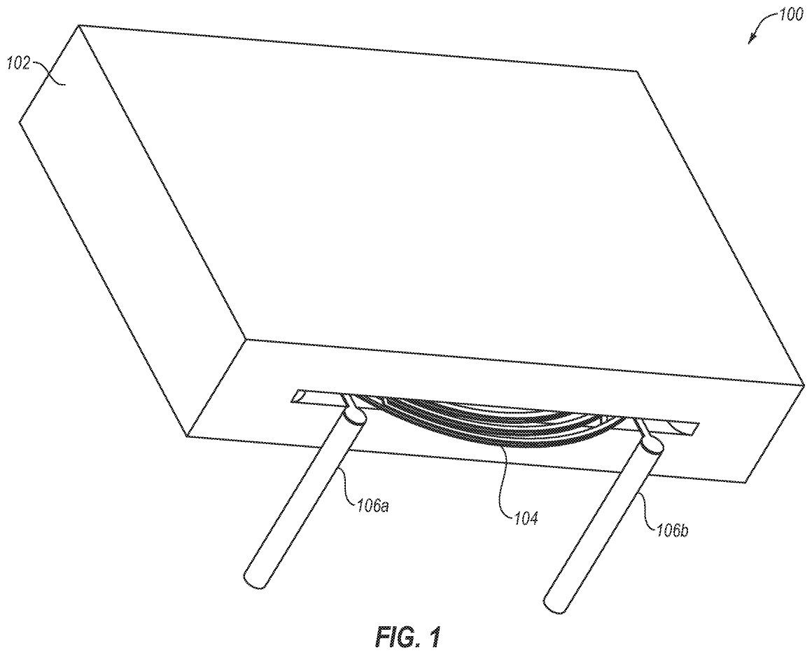

FIG. 1 illustrates an exemplary planar inductor system 100, in accordance with at least one aspect described in the present disclosure. The planar inductor system 100 may include a core 102, a planar inductor 104, a first via 106a, and a second via 106b. The first via 106a and the second via 106b may be referred to as via 106 or vias 106 in the present disclosure. The planar inductor 104 may at least be partially surrounded by one or more PCB layers (e.g., flame retardant (FR4) material). These PCB layers are omitted in FIG. 1 for ease of illustration and discussion of the planar inductor 104. In addition, an illustrated height of the vias 106 relative the core 102 may be increased in FIG. 1 for ease of illustration and to clearly indicate that the vias 106 electrically couple the planar inductor 104 to an external device (e.g., an AC signal source) (not illustrated in FIG. 1).

The planar inductor 104 may include multiple layers with each layer being electrically coupled to a different via 106. Each layer may be formed by a trace that forms multiple turns. The vias 106 may provide an AC signal to the planar inductor 104, which may generate an electromagnetic field based on the AC signal, the number of turns of the planar inductor 104, or some combination thereof.

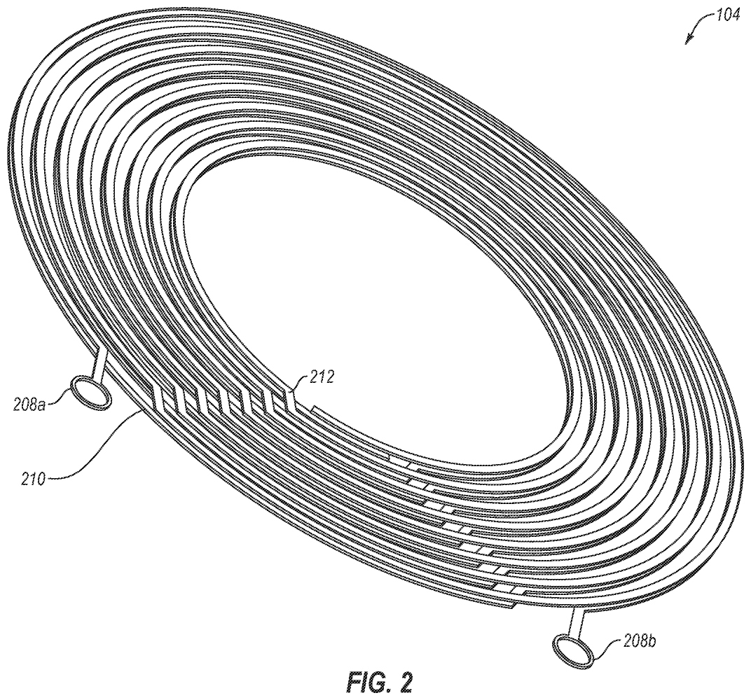

FIG. 2 illustrates an example of the planar inductor 104 of FIG. 1, in accordance with at least one aspect described in the present disclosure. The planar inductor 104 may include electrical connectors 208a-b, a first layer 210, and a second layer 212. A first electrical connector 208a may be electrically coupled to the second layer 212 and the first via 106a (not illustrated in FIG. 2). A second electrical connector 208b may be electrically coupled to the first layer 210 and the second via 106b (not illustrated in FIG. 2).

The first layer 210 and the second layer 212 may be electrically coupled to each other. In addition, the first layer 210 and the second layer 212 may be magnetically coupled (e.g., mutually coupled) to each other via the core 102 (not illustrated in FIG. 2). Magnetically coupling the first layer 210 and the second layer 212 via the core 102 may reduce the number of turns of the planar inductor 104 used to achieve a particular inductance, which may reduce the DC resistance of the planar inductor 104 and in turn may reduce the AC resistance of the planar inductor 104. The planar inductor 104 is illustrated in FIG. 2 as including two layers (e.g., the first layer 210 and the second layer 212). However, the planar inductor 104 may include one layer, two layers, or more than two layers. In addition, the planar inductor is illustrated in FIG. 2 as including a single coil. However, the planar inductor 104 may include one coil, two coils, or more than two coils.

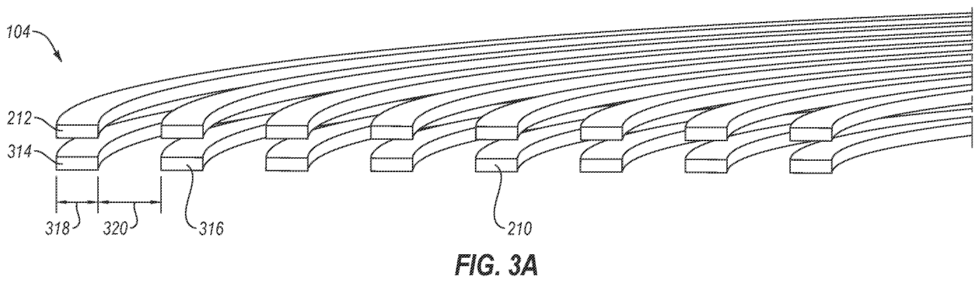

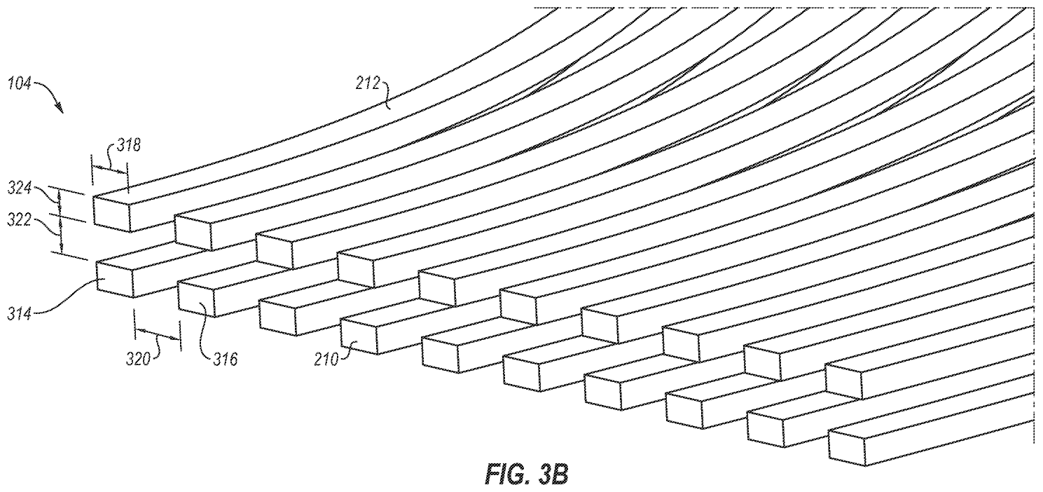

A width of the trace of the first layer 210 and the second layer 212 may be sized so as to increase a distance between turns of the layers 210 and 212 as discussed in more detail below in relation to FIGS. 3A and 3B. The width of the trace may be reduced to decrease the total AC resistance (e.g., the AC resistive losses) of the planar inductor 104 even though reducing the width of the trace may make the DC resistance of the planar inductor 104 higher. The width of the trace may be reduced to increase the distance between the turns, which may reduce the proximity effect resistance of the planar inductor 104.

The inductance rating of the planar inductor 104 may be based on the number of turns of the planar inductor 104, the core material, how large an airgap is used, or some combination thereof. For example, as a number of the turns increases, the inductance rating of the planar inductor 104 may increase and decreasing the airgap may increase the inductance.

FIGS. 3A and 3B illustrate cross sectional views of example configurations of the planar inductor 104 of FIG. 1, in accordance with at least one aspect described in the present disclosure. The first layer 210 may include a first turn 314 and a second turn 316. A width of the trace 318 of the first layer 210 and the second layer 212 (referred to in the present disclosure as a width of the trace 318) may be the same or similar. In addition, a distance between the first turn 314 and the second turn 316 (referred to in the present disclosure as a distance between turns 320) may be determined according to a first ratio discussed in more detail below. A distance between the first layer 210 and the second layer 212 (referred to in the present disclosure as a distance between layers 322) may be determined according to a second ratio discussed in more detail below. A thickness of the trace of the first layer 210 and the second layer 212 (referred to in the present disclosure as a thickness of the trace 324) may be determined according to the first ratio. In FIGS. 3A and 3B, a single instance of the width of the trace 318, the distance between turns 320, the distance between layers 322, and the thickness of the trace 324 are illustrated and described for simplicity of illustration and discussion. In addition, two instances of the turns (e.g., the first turn 314 and the second turn 316) are illustrated and described for simplicity of illustration and discussion.

The width of the trace 318 of the first layer 210 and the second layer 212 throughout the trace may be the same as or equivalent to the width represented by the arrow numbered 318. The distance between each turn of the first layer 210 and each turn of the second layer 212 may be the same as or equivalent to the distance represented by the arrow numbered 320. The thickness of each turn of the first layer 210 and each turn of the second layer 212 may be the same as or equivalent to the thickness represented by the arrow numbered 324.

The planar inductor 104 may be physically positioned, sized, or some combination thereof according to the first ratio (e.g., a ratio of the width of the trace 318 divided by the distance between the turns 320) so as to reduce the total AC resistance of the planar inductor 104 over a range of frequencies. The first ratio may be determined according to Equation 2 (e.g., the width of the trace 318 divided by the distance between turns 320).

The distance between the first layer 210 and the second layer 212 may be determined according to the second ratio (e.g., a ratio of a number multiplied by the distance between turns 320) so as to reduce the total AC resistance of the planar inductor 104 over the range of operating parameters. The second ratio may be determined according to Equation 3. The second ratio may cause mutual inductance between a portion of the trace and a neighboring portion of the trace of the same coil (e.g., mutual inductance between turns of the same coil) to be equal to the mutual inductance of the portion of the trace and the neighboring portions of the trace that are physically positioned below or above the trace (e.g., mutual conductance between turns of the same coil, different coils, or some combination thereof).

The first ratio and the second ratio may cause values of the distance between turns 320 and the width of the trace 318 to be counter to conventional planar magnetic designs. Meaning, the first ratio and the second ratio may cause the width of the trace to be reduced (e.g., smaller values of the width of the traces 318) to reduce the total AC resistance of the planar inductor. The thinner traces of the planar inductor 104 according to the first ratio and the second ratio may reduce the total AC resistance of the planar inductor 104 a greater amount than thicker traces (e.g., greater values of the width of the traces 318) due to the proximity effect resistance being reduced by a greater amount than in corresponding increase in DC resistance.

The first ratio and the second ratio may increase the distance between layers 322, the distance between turns 320, or some combination thereof to decrease the proximity effect resistance of the planar inductor 104. Increasing the distance between turns 320 may cause the width of the trace 318 to be proportionally reduced, which may increase the DC resistance of the planar inductor 104 but due to significantly less proximity effect, the overall AC resistance of the planar inductor 104 may be reduced.

A weight of the trace (e.g., a weight of the copper used for the trace) may be based on a specific implementation of the planar inductor 104. The weight of the trace may be between one-ounce and ten-ounces. The weight of the trace being between two ounces and three ounces may reduce the AC resistance more so than weights between one ounce and two ounces and three ounces and four ounces. For a trace larger than four ounces, a wall of the trace may become tall enough to increase the proximity effect resistance.

In some aspects, the planar inductor 104 may include as few coils as possible for a particular inductance rating. The number of coils may change in multiples of two, as that may permit the coils to be connected on an outside edge of the PCB. The planar inductor 104 may include two, four, six, or more coils.

The planar inductor 104 may include multiple coils that each include one or more layers. Each coil may be formed by a different trace. Each trace may be the same or similar size (e.g., the width, the thickness, and weight of the traces may be the same or similar as each other). Each layer may include multiple turns formed by a corresponding trace. A distance between the turns of the layers may be determined according to Equation 2. For a multiple coil configuration, a represents the width of the traces and b represents the distance between the turns of the traces. In addition, a distance between the coils, the layers, or some combination thereof may be determined according to Equation 3. For a multiple coil configuration, b represents the distance between the turns of the traces. The coils may be magnetically coupled (e.g., mutually coupled) to each other via the core.

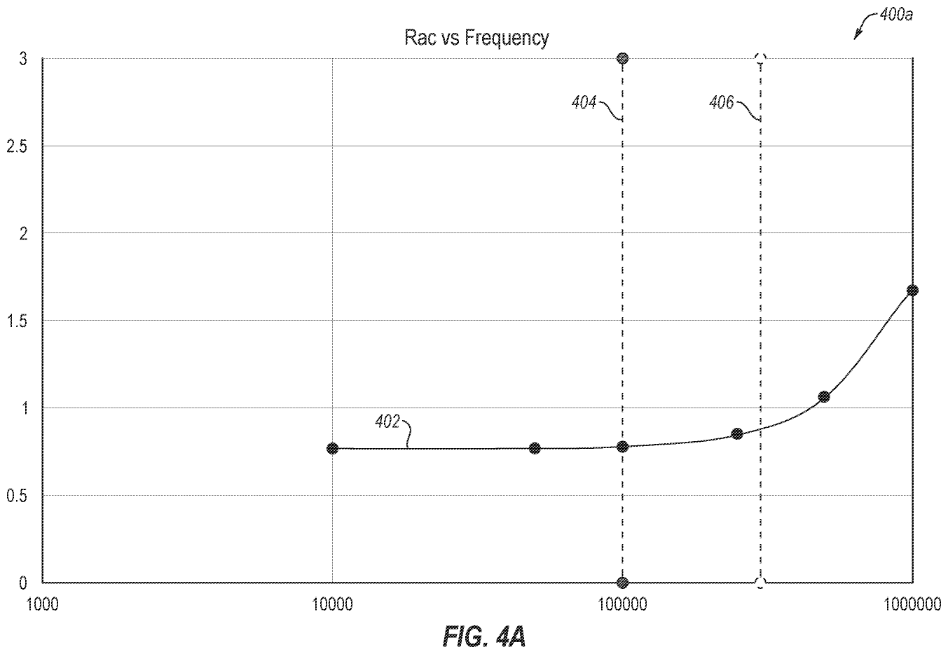

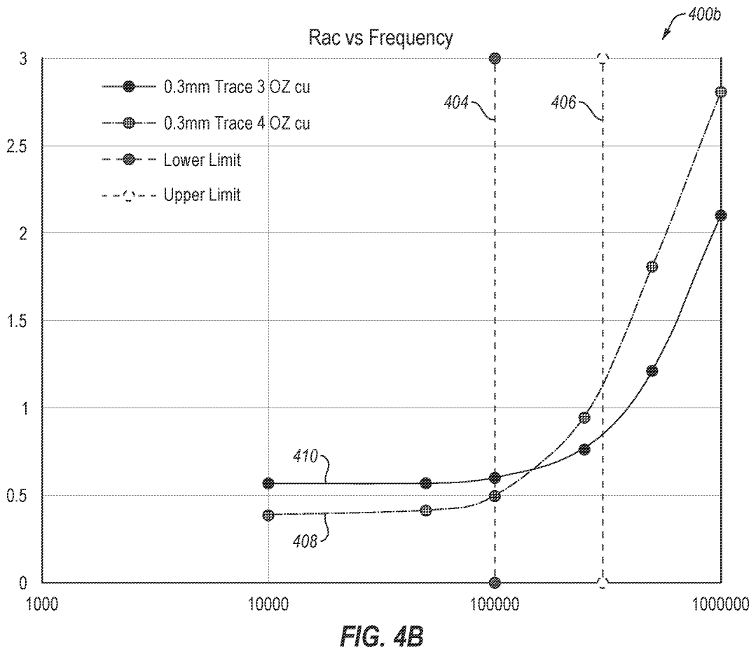

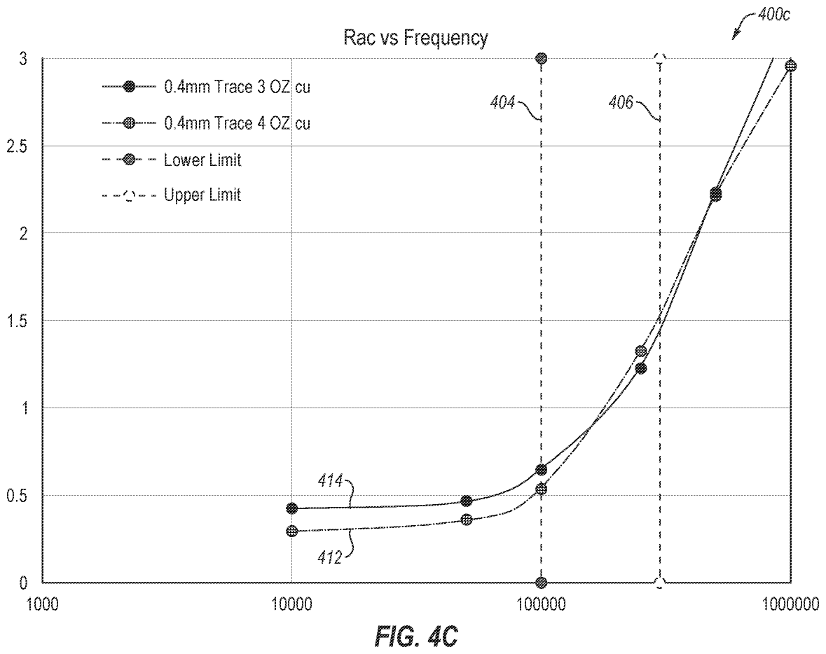

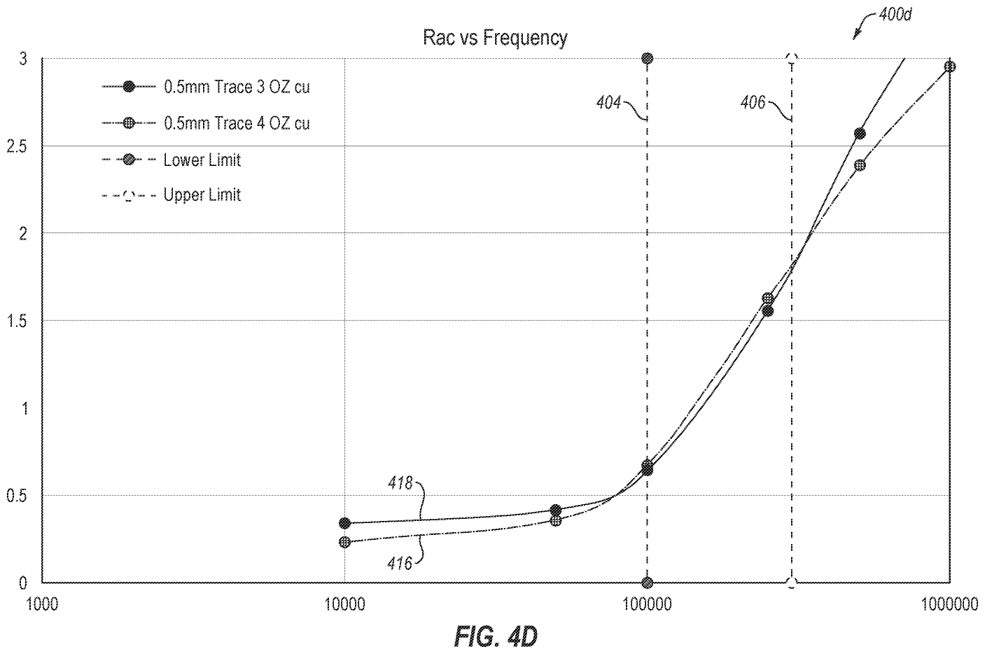

FIGS. 4A-4D illustrate graphical representations 400a-400d of simulations performed using a planar inductor that is physically positioned and sized according to the first ratio and the second ratio, in accordance with at least aspect described in the present disclosure. Curve 402, curve 408, curve 410, curve 412, curve 414, curve 416, and curve 418 represent the measured total AC resistance of the planar inductor over a range of frequencies (1000 hertz to 1,000,000 hertz) for various trace widths and various trace weights.

For curve 402, the trace width was 0.15 millimeters, and the trace weight was four ounces of copper. For curve 408, the trace width was 0.3 millimeters, and the trace weight was four ounces of copper. For curve 410, the trace width was 0.3 millimeters, and the trace weight was three ounces of copper. For curve 412, the trace width was 0.4 millimeters, and the trace weight was four ounces of copper. For curve 414, the trace width was 0.4 millimeters, and the trace weight was three ounces of copper. For curve 416, the trace width was 0.5 millimeters, and the trace weight was four ounces of copper. For curve 418, the trace width was 0.5 millimeters, and the trace weight was three ounces of copper. Curves 404 and 406 represent a lower limit and an upper limit, respectively of the frequencies of operation.

As illustrated in FIGS. 4A-4D, the trace width of 0.15 millimeters and the trace weight of four ounces of copper was measured as being the lowest AC resistance, which indicates that the first ratio and the second ratio decreases the total AC resistance of the planar inductor compared to wider or heavier weights of traces. In addition, as illustrated in FIGS. 4A-4D, as the thickness of the trace increases, the total AC resistance increases proportionally. The total AC resistance increases proportionally due to the proximity effect of neighboring traces. Further, the trace weights of two ounces or three ounces of copper may reduce the total AC resistance more so than one ounce and four ounces.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to aspects containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although aspects of the present disclosure have been described in detail, various changes, substitutions, and alterations could be made hereto without departing from the spirit and scope of the present disclosure.

Unless specific arrangements described herein are mutually exclusive with one another, the various implementations described herein can be combined to enhance system functionality and/or to produce complementary functions. Such combinations will be readily appreciated by those skilled in the art given the totality of the foregoing description. Likewise, aspects of the implementations may be implemented in standalone arrangements where more limited and thus specific component functionality is provided within each of the interconnected—and therefore interacting—system components albeit that, in sum, they together support, realize, and produce the described real-world effect(s). Indeed, it will be understood that unless features in the particular implementations are expressly identified as incompatible with one another or the surrounding context implies that they are mutually exclusive and not readily combinable in a complementary and/or supportive sense, the totality of this disclosure contemplates and envisions that specific features of those complementary implementations can be selectively combined to provide one or more comprehensive, but slightly different, technical solutions. It will, therefore, be appreciated that the above description has been given by way of example only and that modification in detail may be made within the scope of the present invention.

The present invention may be embodied in other specific forms without departing from its spirit or essential characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A planar inductor configured to operate according to planar magnetics, the planar inductor comprising:
a first coil comprising a first trace that forms a first plurality of turns; and
a second coil comprising a second trace that forms a second plurality of turns, wherein:
a distance between the turns of the first plurality of turns is equal to a distance between the turns of the second plurality of turns;
a width of the first trace is equal to a width of the second trace; and
the first coil and the second coil are physically positioned or sized according to:
a/b
in which, a represents the width of the first trace and b represents the distance between the turns of the first plurality of turns.

2. The planar inductor of claim 1, wherein a value of a/b is equal to 1.3.

3. The planar inductor of claim 1, wherein a distance between the first coil and the second coil is determined according to:
1.12×b
in which b represents the distance between the turns of the first plurality of turns.

4. The planar inductor of claim 1 further comprising a third coil comprising a third trace that forms a third plurality of turns, wherein:
a distance between the turns of the third plurality of turns is equal to the distance between the turns of the first plurality of turns;
a width of the third trace is equal to a width of the first trace; and
the third coil and the second coil are also physically positioned or sized according to a/b.

5. A planar inductor configured to operate according to planar magnetics, the planar inductor comprising:
a coil comprising:
a trace;
a first layer comprising a first plurality of turns formed by the trace; and
a second layer comprising a second plurality of turns formed by the trace, wherein:
a distance between the turns of the first plurality of turns is equal to a distance between the turns of the second plurality of turns; and
the first layer and the second layer are physically positioned or sized according to:
a/b
in which, a represents a width of the trace and b represents the distance between the turns of the first plurality of turns.

6. The planar inductor of claim 5, wherein a value of a/b is equal to 1.3.

7. The planar inductor of claim 5, wherein a distance between the first layer and the second layer is determined according to:
1.12×b
in which b represents the distance between the turns of the first plurality of turns.
